(19) United States
(12) Patent Application Publication
(10) Pub. No.: US 2005/0177452 A1
(43) Pub. Date: Aug. 11, 2005

(54) Method and apparatus for like kind compensation system

(76) Inventor: Felton Thomas Colwell, Minnetonka, MN (US)

Correspondence Address: MERCHANT & GOULD PC, P.O. BOX 2903, MINNEAPOLIS, MN, 55402-0903, US

(21) Appl. No.: 10/989,735

(22) Filed: Nov. 15, 2004

Related U.S. Application Data
(60) Provisional application No. 60/520,473, filed on Nov. 14, 2003.

(51) Int. Cl. G06F 17/60

(52) U.S. Cl. 705/26

(57) ABSTRACT

The present invention provides for a system, apparatus and method for utilizing the manufacturing cost efficiencies of a regional/national manufacturer with the delivery time efficiencies of a local manufacturer. Such a system may be implemented by providing a received order to a local third party manufacturer. Because of the relative costs of the manufactured goods between the regional/national and the local third party manufacturer, and the price willing to be paid by the customer, the regional manufacturer does not compensate the local third party manufacturer with currency in the transaction. Instead, the local third party manufacturer is compensated in equivalent or greater products (or optionally credits) at a later date.

### CROSS-REFERENCE TO RELATED APPLICATION

This application claims the benefit of U.S. Provisional Application Ser. No. 60/520,473, filed on Nov. 14, 2003 entitled METHOD AND APPARATUS FOR LIKE KIND COMPENSATION. Such application is incorporated herein by reference.

### FIELD OF THE INVENTION

This invention relates generally to a method and apparatus for manufacturing window covering products; more particularly, to a system, method and apparatus for utilizing third party manufacturing facilities for window covering orders to efficiently manufacture and deliver the ordered products to the ordering party; and more particularly still to subsequently compensating the third party manufacturer in like kind goods.

### BACKGROUND OF THE INVENTION

Window coverings are often manufactured based upon a customer's order. The alternative window coverings (AWC) industry provides soft and hard window treatments to customers desiring window coverings other than conventional draperies. Hard window treatments include faux wood and wood horizontal blinds, vinyl and metal horizontal blinds, vertical blinds and interior shutters. Soft window treatments include cellular shades, pleated shades, roller shades, soft shades, vertical blinds and soft window shadings.

AWC products are offered to customers through a variety of retail channels, including home product centers, independent retailers, discount department stores, retail fabricators, department stores, catalogs, internet, home builders and interior designers and decorators. About twenty percent (20%) of the total sales volume in the AWC industry represents products sold from retail stock, i.e., ready-made products. The balance of the sales volume is made up of custom-made product purchases. Typically custom-made products are manufactured by a wholesale fabricator or a retail fabricator and are then sold directly to customers or to a retail source that, in turn sell the completed product to the customer. Oftentimes, the orders placed by the customer are required to be filled very rapidly.

By customer, what is meant is that customer can be an ultimate end-user customer or a reseller customer. The reseller customers can include, a designer, a decorator, a home product specialty store and/or a home improvement store. It will be appreciated that such reseller customers may carry an inventory that requires rapid replenishment and/or such reseller customer may offer its customers a service by providing custom-order products/systems. In either event, delivery of the custom-order AWC products in a rapid time frame may be desirable or necessary. In the case of rapid replenishment, the order for replenishment may be “custom-order” in the sense that it is an order to replenish a specific size, type, and/or style. However, may not necessarily be a custom-order for a particular end-user customer.

Due to labor and tax costs (among other cost of goods sold components) varying by region of the United States and within other countries, it is often desirable to manufacture AWC products in certain regions of the United States and/or in other countries to reduce the costs of the manufactured product. However, establishing manufacturing facilities requires expending significant capital. Therefore, companies usually consolidate manufacturing facilities to a single or small number of physical locations. Such facilities are located at fixed geographical locations (such facilities and locations, however, may change from time to time).

Because the facilities are generally physically fixed, the facilities vary in geographical distance from the delivery destination for any individual custom-order product. In some cases, the facilities may be hundreds, if not thousands, of miles away from the ordering customer(s). Therefore, while labor and other manufacturing costs may be efficient for a given manufacturing facility, because of the distance involved, the delivery time may not be efficient enough to satisfy certain customers.

Other localized third party manufacturing facilities exist. Such localized third party manufacturing facilities are generally established to provide products to a smaller geographical area. While such facilities can provide manufactured products rapidly within the smaller geographic area, they may not take advantage of reduced labor and other manufacturing costs (i.e., wherein lower costs may be available in other regions/countries). Further, the localized third party manufacturing entity may not be able to sell to all of the customers in the area. For example, due to its relatively high costs, the localized third party manufacturing entity may not be able to sell its goods at competitive prices for certain customers.

Therefore, there arises a need for a system, apparatus and method to take advantage of the lower costs of a regional/national manufacturer, while also taking advantage of the lower delivery time available from local third party manufacturers. The present invention directly addresses and overcomes the shortcomings of the prior art.

### SUMMARY OF THE INVENTION

The present invention provides for a system, apparatus and method for utilizing the manufacturing cost efficiencies of a regional/national manufacturer with the delivery time efficiencies of a local manufacturer. Such a system may be implemented by providing a received order to a local third party manufacturer. Because of the relative costs of the manufactured goods between the regional/national and the local third party manufacturer, and the price willing to be paid by the customer, the regional manufacturer does not compensate the local third party manufacturer with currency in the transaction. Instead, the local third party manufacturer is compensated in equivalent or greater AWC products (or optionally credits) at a later date.

By compensating the local third party manufacturer in this manner, even though the local third party manufacturer likely has higher manufacturing costs, it can be involved in the transaction since it is paid in like-kind goods. It will be appreciated that the like kind goods have a greater value to the local third party manufacturer than the regional/national manufacturer. Therefore, even though the local third party manufacturer has delivered a product having a cost that is higher than what the customer may have been willing to pay (and/or with a cost lower than the price the customer may have been willing to pay, but with too low of a profit margin for the local third party manufacturer to be willing to be involved in the transaction), the local third party manufacturer can be part of the transaction by eliminating payment by currency.

Money (e.g., currency) for the delivered goods only exchanges hands between the regional/national manufacturer and the customer. By eliminating currency from the transaction between the regional manufacturer and the local third party manufacturer, both efficiencies of manufacturing costs and delivery efficiency can be included in the same transaction.

Therefore, according to one aspect of the invention, there is provided a method for implementing a like kind exchange, the method comprising: receiving an order for an alternative window covering from a customer; forwarding the received order to a local third party manufacturer for manufacturing and delivery to the customer, wherein the local third party manufacturer is geographically proximate the customer; and compensating the local third party manufacturer with like kind alternative window covering compensation.

According to another aspect of the invention, there is provided a system for providing a like kind exchange, the system comprising: means for receiving an order for an alternative window covering from a customer; means for forwarding the received order to a local third party manufacturer for manufacturing and delivery to the customer; and means for compensating the local third party manufacturer with like kind alternative window covering compensation.

According to still another aspect of the invention, there is provided a system for compensating a local manufacturer by providing like kind goods in exchange for delivering products to a customer, the system comprising: a computer system for receiving an order for an alternative window covering from a customer via the internet; a database of local manufacturers and geographical areas; and a processor arranged and configured to: determine whether the order can be fulfilled by a local manufacturer in the database; forward the received order to a local manufacturer for manufacturing and delivery to the customer; and determine the like kind compensation for the local manufacturer.

While the invention will be described with respect to preferred embodiment configurations and with respect to particular devices used therein, it will be understood that the invention is not to be construed as limited in any manner by either such configuration or components described herein. Instead, the principles of this invention extend to any environment in which orders for goods are transferred from the order taking entity to a third party manufacturer for faster delivery to the customer. Further, such order taking manufacturer then delivers like kind goods to the third party manufacturer to avoid raising the transaction cost to the customer. These and other variations of the invention will become apparent to those skilled in the art upon a more detailed description of the invention.

The advantages and features, which characterize the invention, are pointed out with particularity in the claims annexed hereto forming a part hereof. For a better understanding of the invention, however, reference should be had to the drawings which form a part hereof and to the accompanying descriptive matter, in which there is illustrated and described of preferred embodiment of the invention.

### BRIEF DESCRIPTION OF THE DRAWINGS

Referring to the drawings, wherein like numerals represent like parts throughout the several views:

FIG. 1 is a schematic diagram illustrating the logical flow of order, and products, and like-kind compensation in accordance with the principles of the present invention.

FIG. 2 is a schematic diagram illustrating a second embodiment of the present invention, wherein the logical flow of order, products, and like-kind compensation together with a credit account is illustrated.

FIG. 3 is an automated system including the use of computers which may be employed to implement the invention of FIGS. 1 and 2.

FIG. 4 is a logic flow diagram illustrating the steps utilized in implementing the present invention, with portions indicated as optional in order to implement the second embodiment of the present invention when a credit account is utilized.

FIG. 5 is a logic flow diagram illustrating the steps utilized in implementing the second embodiment of the present invention when a third party local manufacturer places an order to utilize a credit balance.

FIG. 6 illustrates representative order fields which may be included in an order in the present system.

### DETAILED DESCRIPTION

A system constructed in accordance with the principles of the present invention may be employed in a variety of environments and with a variety of products. Also, the system may include a number of computer hardware and software components to implement the invention. In each case, however, the principles apply to the transferring of an order from an order receiving entity to a local manufacturer (or fabricator) for rapid delivery to the customer. Simultaneously, the order receiving entity provides the order to its own remote manufacturing facilities for delivery of like kind product to the local manufacturer to replace the product the local fabricator delivers to the customer. In order to induce the local fabricator, the delivered product from the order receiving entity may be at a ratio greater than one-to-one. For example, the order receiving entity may provide the local manufacturer with one, two, three or more products for each one product delivered by the local manufacturer (and/or including some fraction thereof). In this manner, the local manufacturer's rapid delivery time is utilized together with the lower manufacturing costs of the order receiving entity to deliver a lower priced product more rapidly to the customer.

It will be appreciated that the remote manufacturing facility may be owned by a third party as well. In that case, the order receiving entity may function as a broker and/or as a virtual manufacturer. Also, the payment of like kind goods removes currency as the form of compensation as between the order taking entity and the local manufacturer. In a sense this may be considered a form of arbitrage vis-à-vis the order taking entity is able to take advantage of a benefit from a local manufacturer (e.g., a local manufacturer delivering a higher priced good, but with a quicker delivery time) while compensating the local manufacturer with goods having a worth which is lower to the order taking entity than the worth of the same goods to the local manufacturer. In this manner, this system and method may be considered a commoditization of custom products on a microeconomic scale. Because the order receiving entity and the local manufacturer assign different values to the same goods, an assignment of a monetary amount to the goods (as between those two parties) does not need to be made.

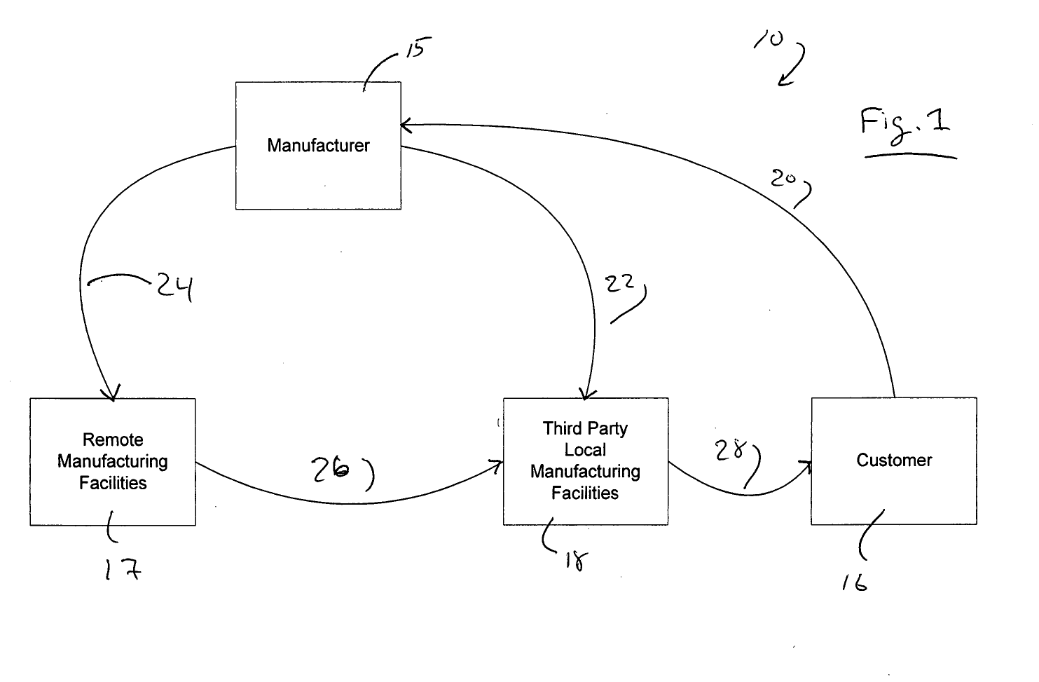

First referring to FIG. 1, the process is shown generally at 10. The regional or national manufacturer 15 is the order taking entity. As used herein, the order taking entity will be referred to as a regional manufacturer. However, it will be appreciated that such manufacturer may have one or more manufacturing facilities in various regions of the United States and/or in other countries (such as Mexico, China, and others). The regional manufacturer has an ongoing or a one time contractual relationship with the customer 16 to deliver AWC products.

As noted above, the term “customer” is not used in a limiting sense and can include end-users or other resellers. It should also be noted that while the environment in which the present invention is employed will be described herein as the manufacture (fabrication) and sale of AWC products, the invention is not limited to this environment. The principles of the present invention may be extended to other custom products and settings.

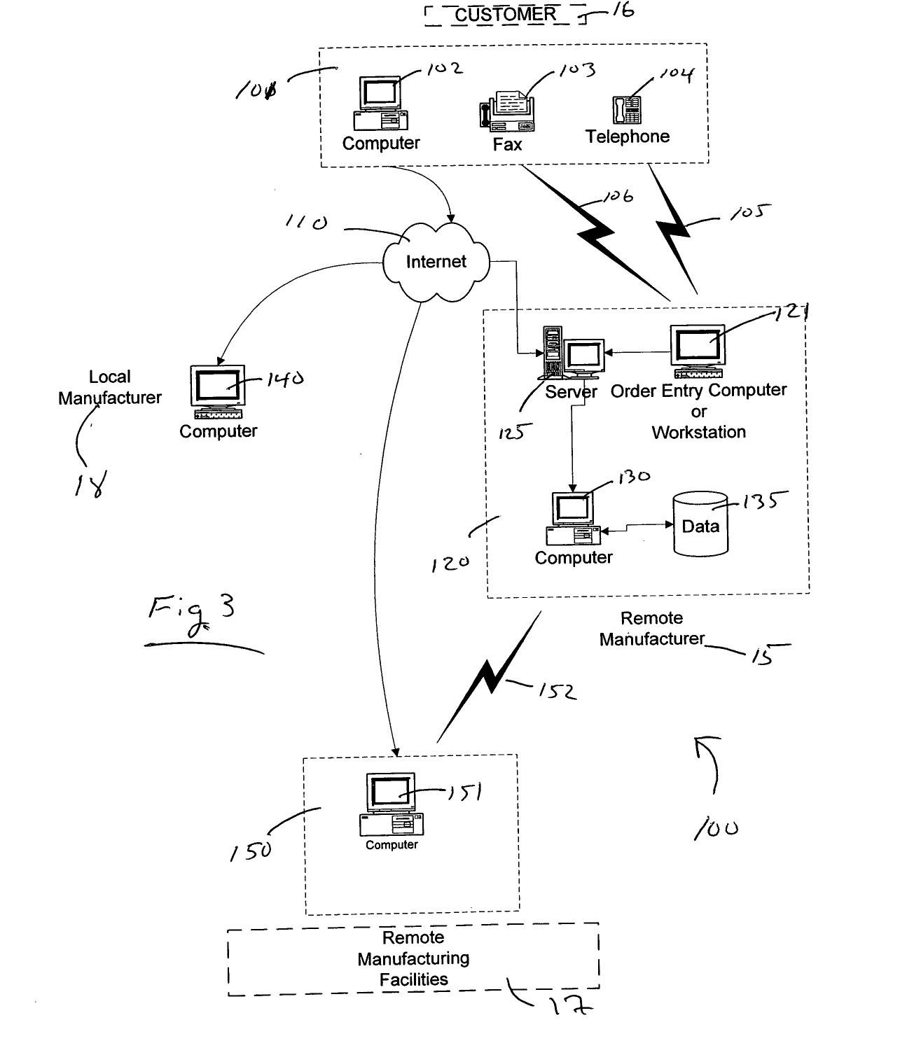

Still referring to FIG. 1, the customer 16 places an order(s) with the regional manufacturer 15. The line designated at 20 illustrates the forwarding of the order to the manufacturer 15. The manner in which the order is forwarded is described in more detail below in connection with FIG. 3. If the required delivery time is within a period that can be accomplished by its own manufacturing facilities 17, then the regional manufacturer 15 may simply provide the order to its own manufacturing facilities 17 in which case the transaction proceeds in an ordinary and customary manner. However, if the requested order delivery time is faster than the remote manufacturing facilities 17 can fabricate and ship the product, then the regional manufacturer provides the order to the third party local manufacturer 18. The third party local manufacturer 18 will generally have manufacturing facilities physically located closer to the customer 16. The passing of this order to the third party local manufacturer is designated at 22. Because of the third party manufacturer's proximity to the customer 16, the ordered goods may be delivered to the end user at 28 (at designation 28) more rapidly than if the manufacturer 15 had manufactured and delivered the goods at its own remote manufacturing facilities 17 for delivery to the customer 16.

As noted above, the relative value assigned to the product(s) delivered to the customer 16 by the regional manufacturer and the third party local manufacturer 18 may differ. If the regional manufacturer 15 had to pay the third party local manufacturer its actual costs (and profit), then the regional manufacturer 15 may not be able to provide that order to the third party local manufacturer 18. This would be due to the customer having certain cost expectations and/or requirements—as well as lead time/delivery requirements. However, by removing monetary compensation from the transaction between the regional manufacturer and the third party manufacturer, then the regional manufacturer 15 can deliver like kind product to the third party local manufacturer 18 without introducing the transaction costs from the differential and relative value assigned to the products.

Accordingly, subsequent or simultaneously with providing the order to the third party local manufacturer 18, the regional manufacturer 15 also provides the order to its remote manufacturing facility 17 at designation 24. The order will generally include both the products ordered by the customer 16 and some specified number of additional AWC products which are agreed upon between the regional manufacturer 15 and the third party local manufacturer 18. Such agreement may be either ad hoc or from a predetermined compensation arrangement between the parties. After the product(s) is manufactured, such product(s) may be delivered at a later date, at designation 26, to the third party local manufacturer 18. Such product manufactured and delivered to the third party local manufacturer 18 is delivered in a greater than 1:1 ratio (e.g., the compensation to the third party local manufacturer 18 is of a greater value to the third party local manufacturer than the product which it delivered to the customer 16).

The result of the transaction is that the customer 16 receives the product which it ordered from the regional manufacturer 15 at a lower price than the third party local manufacturer 18 could deliver it, while at a faster turnaround than the regional manufacturer 15 could have delivered the product. Thus, the customer benefits on both cost and delivery time. Similarly, the regional manufacturer 15 was able to take the order and deliver it to the customer 16 in accordance with the customer's 16 delivery expectations, thereby maintaining the goodwill of the customer 16. The third party local manufacturer 18 also benefits since it receives a like or greater value product, which it can then sell to other customers at its higher assigned value. Accordingly, each party in the transaction benefits from the present invention, and the efficiencies of both the local manufacturer 18 and regional manufacturer 15 create an improvement in productivity.

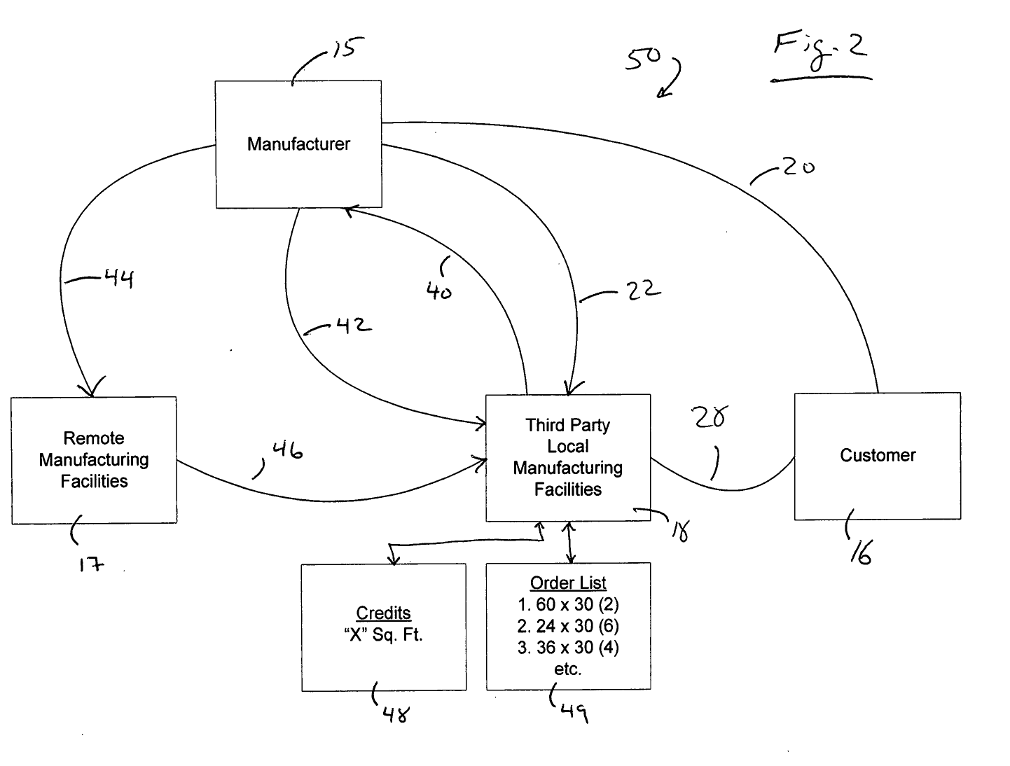

FIG. 2 illustrates an alternative embodiment of the method and system of FIG. 1. The method and system is shown generally at 50. In this embodiment, the regional manufacturer 15 receives the order from the customer 16 at designation 20. Based on lead time for the order, the regional manufacturer 15 may implement the system of this invention by providing the order to the third party local manufacturer 18 at designation 22. The third party local manufacturer 18 manufactures (fabricates) the ordered products and delivers the same to the customer 16 at designation 28.

However, the regional manufacturer does not automatically provide the order to the remote manufacturing facilities 17. Instead, a credit for that third party local manufacturer 18 is established by the regional manufacturer 15 and sent to the local manufacturer 18 at designation 42. The credit is illustrated at block 48 as being due the local manufacturer 18. Such credit may be a “virtual” credit in the sense that it is stored in a computer medium. Therefore, the actual location of the credit may vary so long as the amount of the credit is agreed upon by the two parties. While it is preferable for the parties to agree upon the credit in advance according to a schedule, the credit may be agreed upon between the parties on an ad hoc or some other basis.

It will be appreciated that in the embodiment described above in connection with FIG. 1, the goods delivered from the remote manufacturing facility 17 to the third party local manufacturer were preferably similarly sized goods as the goods delivered to the local manufacturer was based on the same order filled by the local manufacturer—although different size goods may have been provided as an option. In order to offer greater incentive for the local manufacturer 18 to participate in the system 50, flexibility of the like kind compensation products may be offered by establishing the credit. In this case, for example, each square foot delivered product may be compensated at an enhanced rate of square feet of product. Other credit systems might also be employed (an example using minutes per square foot to construct various types of AWC is discussed further below). By utilizing a credit system, the local manufacturer 18 may be able to take one of its lower priority orders (for example the third order on its aggregate order list—which may include some larger number of orders) and utilize its credits with the regional manufacturer 15 to provide the same. In this case, the third party local manufacturer 18 forwards the order to the regional manufacturer 15 at designation 40. The regional manufacturer forwards the credit based order to the remote manufacturing facilities 17 at designation 44, and the manufactured (fabricated) products are delivered to the local manufacturer 18 at designation 46.

The products ordered by the local manufacturer 18 may be made at some time in the future, although the system may provide for an expiration of credits if not utilized within a certain time period.

Turning to FIG. 3, a schematic diagram of the components utilized in connection with the embodiments is presented. In FIG. 3, the system is illustrated generally at 100. The customer 16 utilizes some method and apparatus of generating the order for the customized products at block 101. For example, the order may be sent to the regional manufacturer 15 by telephone 104, facsimile machine 103 and/or computer based ordering system 102. The order may also be mailed to the regional manufacturer. The computer based system 102 can communicate with the regional manufacturer 15 via the internet 110 or via a communication line 106. Generally, facsimile and phone orders are via phone line 105 (although cellular communications may also be used). Remote manufacturer 15 receives the orders at block 120. If the orders are sent by facsimile 103 or phone 104, an order entry person may enter the order at order entry computer 121. All of the computers illustrated in FIG. 3 may be of the Pentium® based PC compatible type and can include a Windows® operated software or the like. The computers operate in a well know manner and may be attached to appropriate output devices such as printers, monitors, and other devices. The computers also include input devices such as a mouse, track ball and/or keyboard among other input devices.

Computer 121 is connected to a server 125 which acts as an entry point to the system 120 for orders from a variety of sources. The server 125 can collect orders from customers via the internet 110 or from communication line 106. Computer 130 acts as the processor for determining the required delivery time of the orders and determining whether the order is directed to the remote manufacturing facilities 17 or whether it is provided to a third party local manufacturer 18. The computer 130 includes a database for storing information on the order including where the order is sent, delivery times, the like kind compensation for different third party local manufacturers, and credits (if established).

Computer 130 transmits the orders to the local manufacturer 18 via the internet 110 to its computer 140. Orders may also be forwarded by facsimile, phone, and express mail. The local manufacturer 18 may acknowledge the order electronically or with a physical confirmation. Also, the local manufacturer 18 may forward an indication when the order is shipped to the customer 16. Preferably, such acknowledgments and indications are performed electronically by computer 140 to computer 130 via the internet 110. In this manner, computer 130 can store the information in database 135 for reporting and tracking purposes. Computer 140 may also be utilized to receive credit information and to initiate credit based orders to the regional manufacturer 15.

Remote manufacturing facilities 17 preferably include an automated system which includes a computer 150 for receiving and transmitting data on orders. Such computer 150 can communicate via the internet 110 or via communication line designated as 152.

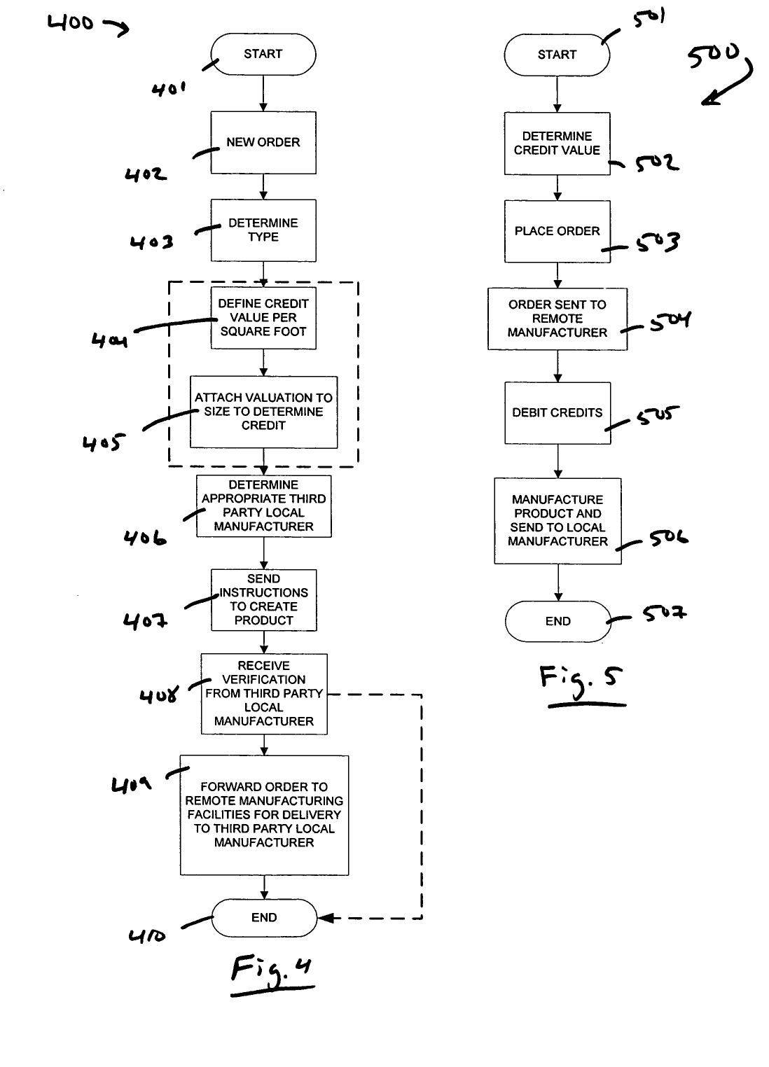

FIG. 4 illustrates an example operation flow for a system for implementing a like kind compensation system according to one possible embodiment of the present invention. The process is generally identified at 400 and starts at 401. It will be appreciated that this embodiment is described in the general context of computer-executable instructions, such as program modules, executed by one or more computers (e.g., by the system identified in FIG. 3) or other devices. Generally, program modules include routines, programs, objects, components, data structures, etc. that perform particular tasks or implement particular abstract data types. Typically the functionality of the program modules may be combined or distributed as desired in various embodiments.

Additionally, the following embodiments described herein are implemented as logical operations performed by one or more programmable processing devices. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

At block 402 the new order is created and entered into the remote manufacturer's system 120 (as generally described above). At block 403, the order is interpreted to determine if the order will be filled in a customary manner and/or if at least a portion of the order will utilize a local third party manufacturer 18 (e.g., the order may take the form of a plurality of orders, some of which require a faster lead time, etc.).

One example of an order with representative order fields is set forth in FIG. 6. The order is generally identified at 600. Particular fields include the color 601, the type 602, the size 603 and construction notes 604. The color field 601 generally includes an indication of the color which describes the ordered AWC. Such color can be a designated color such as “Arctic White” which is selected for the product by the manufacturer and/or a more descriptive color indication convention. The type field 602 generally indicates the type of AWC which is the subject of the order. For example, wood blinds, vinyl blinds, aluminum blinds, vertical blinds, draperies may be specified. The size field 603 generally includes a designation of the size of the ordered AWC. In the example set forth in FIG. 6, the size is 48 and ½″ by 62″. The last field is the construction code field 604. This field can contain information regarding mounting hardware, other necessary construction and mounting specifications, etc.

At blocks 404 and 405, optional steps are set forth. These steps are performed in the second embodiment described above in connection with FIG. 2. In the case of a like kind system in which a multiple of similar products are automatically delivered, then the system may skip directly to block 406. At block 404, the credit value per square foot for the ordered AWC is determined. One such example of determining a credit value is described further below. At block 405, the credit value for the ordered AWC is determined by multiplying the determined credit per square foot by the area of the ordered product.

At block 406, the appropriate third party local manufacturer 18 is determined. Here the process may include a determination of geographical proximity, of a prior agreement to manufacture for a particular customer 16, and/or the willingness to provide product for a lower amount of like kind compensation/credit. At block 407, the instructions are sent to the third party local manufacturer 18. As indicated in FIG. 3, this is preferably accomplished from the manufacturer's system 120 to the local manufacturer's computer 140 via the internet 110. If the local manufacturer 18 accepts the order, an acknowledgement is sent back to the manufacturer 15 at block 408. Such acceptance can be accomplished automatically by computer 140 or can be reviewed on a case by case basis and manually accepted. If a credit system is in place, then step 409 is skipped. However, in the event of a like kind compensation system, at block 409, the order for the like kind AWC product is forwarded to the remote manufacturing facilities. At block 410, the process ends.

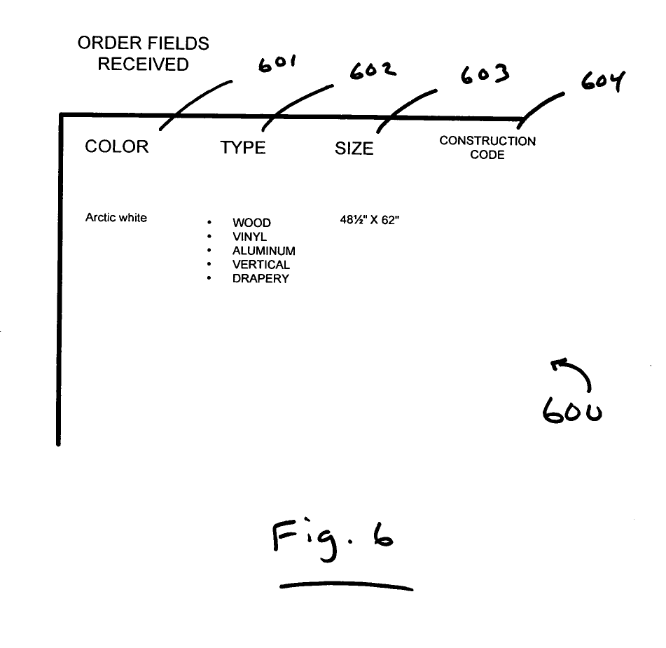

FIG. 5 illustrates the logic flow for an order which placed by the third party local manufacturer 18 when a credit system is utilized. The logic flow is generally identified at 500, and the process begins at block 501. First at block 501, the credit value is determined and compared to the value of the order. If the credit value is sufficient, then the order is forwarded to the manufacturer 15. Once accepted by the manufacturer 15 (preferably automatically with computer system 120) at block 504, the order is passed along to the remote manufacturer 504. The credits utilized by the placed order are then deducted from the third party local manufacturer's 18 account at block 505. Moving to block 506, the ordered AWC product(s) are manufactured and sent to the third party local manufacturer 18. At block 507 the process ends. It will be appreciated that the introduction of credits—which are not based on a monetary scale—keeps the advantages of the present invention intact, but introduces additional advantages to the third party local manufacturer 18. For example, deferring the selection of AWC products and by providing AWC products that may be more highly desired may be advantageous. Optionally, the system may also employ debits (e.g., a system in which the third party local manufacturer 18 orders without credits and then owes product to the manufacturer 15).

One type of credit system that may be employed is a “time-based” credit system. For example, different types of AWC generally take differing amounts of time to construct. These differences can be normalized into a table identifying the minutes per square foot to construct that particular type of AWC. By utilizing time as the normalized basis between the AWC products, the non-monetary nature of the present invention is maintained. An example of such a table is set forth in TABLE I below.

TABLE I

| Type of AWC | Minutes per square foot |
|---|---|
| Wood Blinds | 3.5 |
| Pleated Cellular | 2.1 |
| PVC Blind | 3.0 |
| Aluminum | 0.8 |
| Vertical | 1.35 |
| Faux Wood | 3.0 |

In the foregoing table, it can be seen that wood blinds take a longer time period to manufacture than aluminum. Therefore, if an order is fulfilled by the third party local manufacturer 18 for an aluminum AWC product and subsequently places an order for a wood blind AWC product using credits, then the third party local manufacturer 18 will receive fewer square feet of the wood blinds.

As another example, and assuming that each AWC will have an area of 20 sq ft., if a third party local fabricator accumulated a credit balance of 23,000 minutes, then that fabricator could be compensated with the following items:

328 Wood Blinds

547 Pleated Cellular Blinds

383 PVC Blinds

1,437 Aluminum Blinds

852 Vertical Blinds

383 Faux Wood Blinds

It will be appreciated that some combination of these products could also be provided as compensation. The number of products is arrived at by dividing the credit balance by the square footage (area) of the selected AWC products and by the minutes per square foot factor for that particular product.

It will be appreciated that the principles of this invention apply not only to the type of manufacturing of window coverings, but also to other products in which local manufacturing and off-shore manufacturing at a lower cost is employed. While particular embodiments of the invention have been described with respect to its application, it will be understood by those skilled in the art that the invention is not limited by such application or embodiment or the particular components disclosed and described herein. It will be appreciated by those skilled in the art that other components that embody the principles of this invention and other applications therefore other than as described herein can be configured within the spirit and intent of this invention. The arrangement described herein is provided as only one example of an embodiment that incorporates and practices the principles of this invention. Other modifications and alterations are well within the knowledge of those skilled in the art and are to be included within the broad scope of the appended claims.

1. A method for implementing a like kind exchange, the method comprising:
a) receiving an order for an alternative window covering from a customer;
b) forwarding the received order to a local third party manufacturer for manufacturing and delivery to the customer, wherein the local third party manufacturer is geographically proximate the customer; and
c) compensating the local third party manufacturer with like kind alternative window covering compensation.

2. The method of claim 1, further comprising establishing a credit balance for the local third party manufacturer, wherein the compensation step may be deferred for a period of time.

3. The method of claim 2, wherein the credit balance is in a non-monetary unit.

4. The method of claim 3, wherein the credit balance is determined by multiplying the square foot area of the ordered alternative window covering by a factor for that particular ordered alternative window covering.

5. A system for providing a like kind exchange, the system comprising:
a) means for receiving an order for an alternative window covering from a customer;
b) means for forwarding the received order to a local third party manufacturer for manufacturing and delivery to the customer; and
c) means for compensating the local third party manufacturer with like kind alternative window covering compensation.

6. The system of claim 5, further comprising a memory location for storing an established a credit balance for the local third party manufacturer and processing means for determining the credit balance, wherein the compensation to the local third party manufacturer may be deferred for a period of time.

7. The system of claim 6, wherein the credit balance is in a non-monetary unit.

8. The system of claim 7, wherein the processor determines the credit balance by multiplying the square foot area of the ordered alternative window covering by a factor for that particular ordered alternative window covering.

9. A system for compensating a local manufacturer by providing like kind goods in exchange for delivering products to a customer, the system comprising:
a) a computer system for receiving an order for an alternative window covering from a customer via the internet;
b) a database of local manufacturers and geographical areas; and
c) a processor arranged and configured to:
a. determine whether the order can be fulfilled by a local manufacturer in the database;
b. forward the received order to a local manufacturer for manufacturing and delivery to the customer; and
c. determine the like kind compensation for the local manufacturer.

10. The system of claim 9, further comprising a memory location for storing an established a credit balance for the local manufacturer and processing means for determining the credit balance, wherein the compensation to the local manufacturer may be deferred for a period of time.

11. The system of claim 10, wherein the credit balance is in a non-monetary unit.

12. The system of claim 11, wherein the processor determines the credit balance by multiplying the square foot area of the ordered alternative window covering by a factor for that particular ordered alternative window covering.
